(19) United States
(12) Patent Application Publication
(10) Pub. No.: US 2006/0207898 A1
(43) Pub. Date: Sep. 21, 2006

(54) Thermos bag for baseball bat

(76) Inventor: Huei-Wen Cheng, Taoyuan (TW)

Correspondence Address: TROXELL LAW OFFICE PLLC, Suite 1404, 5205 Leesburg Pike, Falls Church, VA, 22041, US

(21) Appl. No.: 11/082,810

(22) Filed: Mar. 18, 2005

(51) Int. Cl. B65D 85/20; F24C 1/00; H05B 3/06

(52) U.S. Cl. 206/315.1; 219/533; 219/527; 126/226

(57) ABSTRACT

A thermos bag for a baseball bat comprises a bag body and a heater. The inside of the bag body is divided into an inner pocket and an outer pocket by a lining. By unzipping a zipped opening formed on the upper portion of the bag body, the baseball bat can be held inside the outer pocket. A lateral pocket having a cover is mounted on the outside of the bag body. An electric power device and a control apparatus of the heater are held inside the lateral pocket. A power switch is electrically connected to the control apparatus to turn on or turn off a heating device such that the temperature inside the bag body can be maintained to ensure that the crystal structure of the aluminum baseball bat is stable and that the original tenacity and the malleability is maintained to prevent the baseball bat from crack.

### FIELD OF THE INVENTION

The present invention relates to a thermos bag for a baseball bat, and more particularly to a thermos bag having a bag body for holding the baseball bat and a heating device for generating heat, wherein the heat is delivered to the baseball bat and maintained for a period of time to avoid batting in low temperature and ensure that the crystal structure of the aluminum baseball bat is stable and that the original tenacity and the malleability is maintained to prevent the baseball bat from crack.

### BACKGROUND OF THE INVENTION

The baseball sport is originated from a long time ago and has been become one of the popular sports. The viewable point of the baseball sport consists in the perfect defense of the defenders and the hitting power of the attackers. A home run hit by the batter especially makes a greatest impact on the ball game fans. In order to allow the baseball to be fallen at a farther distance, the baseball bat for batting is one of the most important tools for the sportsmen, wherein the aluminum baseball bat provides the best efficacy.

However, because of its soft texture the aluminum metal is not suitable for the baseball bat. Accordingly, the aluminum baseball bat is mostly made up of the alloy of the aluminum metal and other trace metal elements so as to alter the crystal structure of the aluminum baseball bat. The tensile force, staying power, hardness, and impact value of the aluminum baseball bat are altered depending on variations in its crystal structure. In addition, the variation in temperature also alters the crystal structure and alters its original metal property.

Accordingly, batting in low temperature results in the little variation in the crystal structure of the baseball bat. Accordingly, the rigidity of the aluminum alloy is strengthened and the aluminum baseball bat becomes more fragile. After the powerful batting from the batter, the contact point of the baseball bat that contacts the baseball produces cracks. Consequently, the baseball bat cannot be used and the loss is thus caused.

### SUMMARY OF THE INVENTION

In view of the drawbacks of the conventional technique, the present invention discloses a thermos bag for a baseball bat for use in the industry.

The main object of the present invention is to provide a thermos bag for holding an aluminum baseball bat to maintain its original tenacity and the malleability and prevent the baseball bat from crack.

It is another object of the present invention to provide a thermos bag that provides an electric power device for accumulating charge to carry it easily. It is not restricted to the indoor use or the outdoor use. The heating operation can be performed at any time in accordance with personal need to provide the best protection for the baseball bat.

In order to achieve the above-mentioned objects, the thermos bag, which is composed of a bag body and a heater, is provided, wherein the inside of the bag body is divided into an inner pocket and an outer pocket by a lining. A baseball bat is put inside the outer pocket and a heating device is mounted in the inner pocket. The heating device is powered by an electric power device to generate heat. By means of the heat-absorption property of the lining and the hermetically sealed space of the bag body, the temperature inside the bag body can be maintained for a period of time to ensure that the crystal structure of the aluminum baseball bat is stable and that the original tenacity and the malleability is maintained to prevent the baseball bat from crack.

The other features and preferred embodiments of the present invention will now be described with reference to the accompanying drawings.

### BRIEF DESCRIPTION OF THE DRAWINGS

FIG. 1 is a plane view showing the outward appearance of the thermos bag for the baseball bat in accordance with the present invention.

FIG. 2 is a schematic cross-section view showing the thermos bag for the baseball bat in accordance with the present invention.

FIG. 3 is a schematic view showing the operation of the thermos bag.

### DETAILED DESCRIPTION OF THE PREFERRED EMBODIMENT

The detailed structural feature and the preferred embodiment of the present invention will now be described in detail with reference to the accompanying drawings.

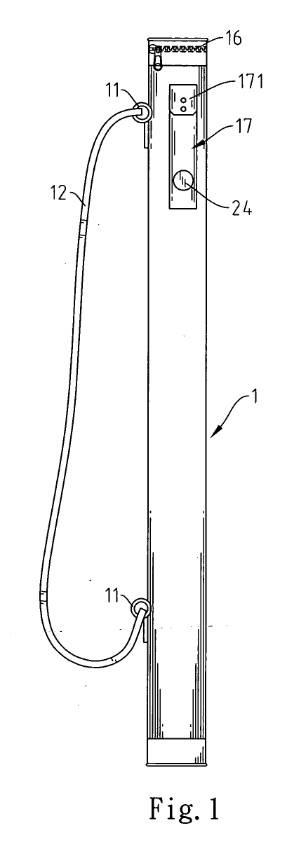

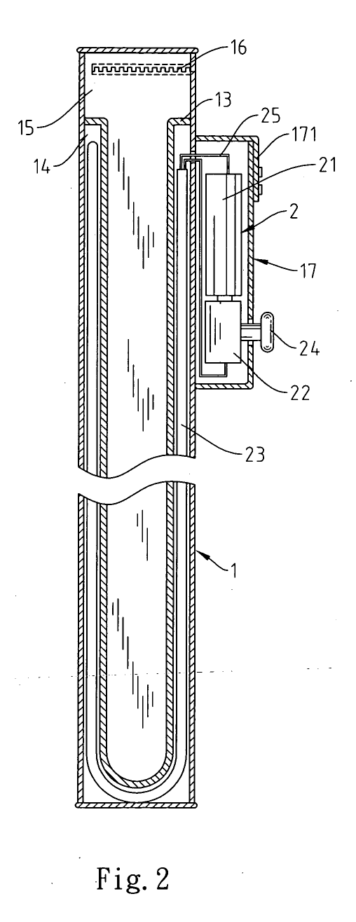

Referring to FIG. 1 and FIG. 2, a thermos bag for a baseball bat of the present invention comprises a cylindrical bag body 1 and a heater 2, wherein the bag body 1 is made of airproof material and longer in length than the baseball bat 10, and a ring 11 to be hooked by a strap 12 is mounted respectively on the proper upper portion and lower portion on the same side of the exterior periphery of the bag body 1. The inside of the bag body 1 is divided into two article-holding rooms namely an inner pocket 14 and an outer pocket 15 by a lining 13. By unzipping a U-shaped zipped opening 16 formed on the upper portion of the bag body 1, the baseball bat 10 can be held inside the outer pocket 15.

A lateral pocket 17 is mounted in a proper position on the outside of the bag body 1. The lateral pocket 17 can be closed by closing a cover 171 that connects to the upper end of the lateral pocket 17. An electric power device 21 and a control apparatus 22 of the heater 2 are held inside the lateral pocket 17 after the cover 171 is open. After the electric power device 21 and the control apparatus 22 are connected with one another, the both sides thereof are respectively connected to a heating device 23 in parallel by means of their respective signal wires 25 that pierce through the bag body 1. A power switch 24 is electrically connected to the control apparatus 22 and mounted on the outside of the lateral pocket 17 to turn on or turn off the heating device 23. The heating device 23 is mounted inside the inner pocket 14 of the bag body 1 and powered by the electric power device 21 to generate heat. The heat is delivered to the outer pocket 15 of the bag body 1 through the lining 13 that mounts on the inner periphery of the bag body 1 to maintain an adequate temperature for the bag body 1. The thermos bag for the baseball bat is portable and convenient because the electric power device 21 can accumulate charge and provides the portability. It is not restricted to the indoor use or the outdoor use. The heating operation can be performed at any time in accordance with personal need to provide the best protection for the baseball bat 10.

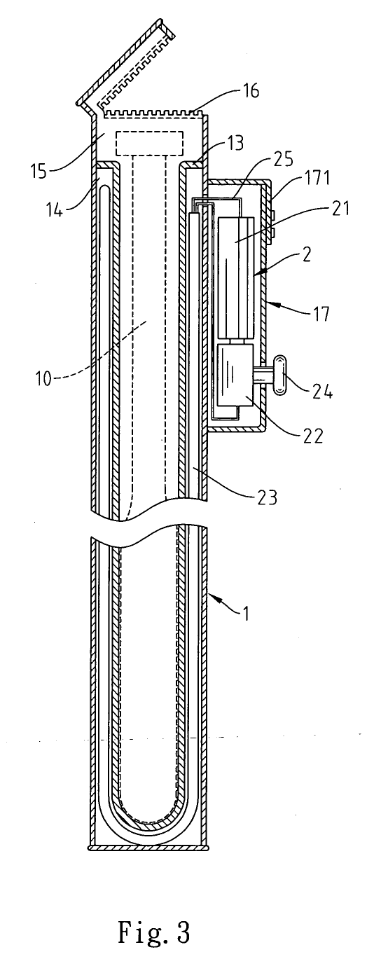

Referring to FIG. 3, a preferred embodiment of the present invention is shown. The zipped opening 16 on the upper portion of the bag body 1 is unzipped, and the baseball bat 10 is put into the outer pocket 15 of the bag body 1. After that the zipped opening 16 is zipped so as to make the bag body 1 form a hermetically sealed space. The power switch 24 is then turned on to allow the heating device 23 to heat up. The heat generated by the heating device 23 can heat the lining 13 directly, and through the lining 13 the heat is then delivered to the baseball bat 10 that locates inside the outer pocket 15 of the bag body 1. Besides, the control apparatus 22 allows the heating device 23 to be turned off when it is heated up to a predetermined temperature such as about 40 degrees Centigrade. Because of the heat-absorption property of the lining 13 and the hermetically sealed space of the bag body 1, the temperature inside the bag body 1 can be maintained for a period of time to ensure that the crystal structure of the aluminum baseball bat 10 is stable and that the original tenacity and the malleability is maintained to prevent the baseball bat 10 from crack.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A thermos bag for a baseball bat comprising:
a bag body, wherein the inside of the bag body is divided into an inner pocket and an outer pocket by a lining and a lateral pocket having a heater mounted therein is mounted on the outside of the bag body; and
the heater consisting of an electric power device, a control apparatus, and a heating device, wherein a power switch is mounted on the outside of the lateral pocket and the both sides of the connected electric power device and control apparatus are respectively connected to the heating device in parallel by means of their respective signal wires that pierce through the bag body, thereby the power switch is turned on to allow the heating device to heat the lining directly and the generated heat is delivered to the baseball bat that locates inside the outer pocket of the bag body through the lining.
